(19) United States
(12) Patent Application Publication
(10) Pub. No.: US 2024/0324041 A1
(43) Pub. Date: Sep. 26, 2024

(54) WIRELESS COMMUNICATION DEVICE, METHOD FOR CONTROLLING WIRELESS COMMUNICATION DEVICE, AND NON-TRANSITORY COMPUTER-READABLE STORAGE MEDIUM STORING PROGRAM

(71) Applicant: SEIKO EPSON CORPORATION, Tokyo (JP)

(72) Inventor: Kota NISHIDA, SHIOJIRI-SHI (JP)

(21) Appl. No.: 18/612,317

(22) Filed: Mar. 21, 2024

(30) Foreign Application Priority Data
Mar. 24, 2023 (JP) 2023-047660

(51) Int. Cl. H04W 76/15; H04W 8/00; H04W 76/30

(52) U.S. Cl. CPC H04W 76/15; H04W 8/005; H04W 76/30

(57) ABSTRACT

A wireless communication device includes: a first communication processor that establishes a wireless communication connection of a first wireless communication system using setting information; a second communication processor that searches for at least one other wireless communication device according to an NAN standard and establishes a wireless communication connection of a second wireless communication system; and a transmission controller that performs control to transmit the setting information to the at least one other wireless communication device using the wireless communication connection of the second wireless communication system. The second communication processor disconnects the wireless communication connection of the second wireless communication system to the other wireless communication device when the other wireless communication device successfully establishes the wireless communication connection of the first wireless communication system.

The present application is based on, and claims priority from JP Application Serial Number 2023-047660, filed Mar. 24, 2023, the disclosure of which is hereby incorporated by reference herein in its entirety.

### BACKGROUND

### 1. Technical Field

The present disclosure relates to a wireless communication device, a method for controlling a wireless communication device, and a non-transitory computer-readable storage medium storing a program.

### 2. Related Art

In Wi-Fi Aware which is one of Wi-Fi Alliance certification programs, a communication protocol called a neighbor awareness network (NAN), which wirelessly communicates between devices without using an access point, is defined. Hereinafter, a standard for the NAN defined by Wi-Fi Alliance is referred to as an NAN standard. JP-A-2019-134322 discloses a technique in which a printer establishes a wireless local area network (LAN) connection by transmitting and receiving information for the wireless LAN connection between a user terminal and the printer using an NAN data link which is a wireless communication connection according to an NAN standard.

JP-A-2019-134322 is an example of the related art.

In the technique disclosed in JP-A-2019-134322, the NAN data link is disconnected immediately after the information for the wireless LAN connection is transmitted and received. Therefore, when an error occurs in the transmission of the information and the wireless LAN connection cannot be successfully established, the user terminal and the printer need to perform processing of establishing the NAN data link again in order to transmit the information again. That is, when the information is transmitted again, an amount of processing for establishing the wireless communication connection increases. Therefore, there is a demand for a technique for reducing the amount of processing for establishing the wireless communication connection.

### SUMMARY

A wireless communication device according to the present disclosure includes: a first communication processing unit configured to establish a wireless communication connection of a first wireless communication system using setting information; a second communication processing unit configured to search for at least one other wireless communication device according to an NAN standard and establish, with the at least one other wireless communication device, a wireless communication connection of a second wireless communication system different from the first wireless communication system, the second wireless communication system being a communication system according to the NAN standard; and a transmission control unit configured to perform control to transmit the setting information to the at least one other wireless communication device using the wireless communication connection of the second wireless communication system, in which the second communication processing unit is configured to disconnect the wireless communication connection of the second wireless communication system to the other wireless communication device when the other wireless communication device successfully establishes the wireless communication connection of the first wireless communication system.

A wireless communication device according to the present disclosure includes: a first communication processing unit configured to establish, with other wireless communication device, a wireless communication connection of a first wireless communication system according to an NAN standard; a setting information acquisition unit configured to acquire setting information from the other wireless communication device using the wireless communication connection of the first wireless communication system; and a second communication processing unit configured to establish a wireless communication connection of a second wireless communication system different from the first wireless communication system using the setting information, in which the first communication processing unit is configured to disconnect the wireless communication connection of the first wireless communication system when the establishment of the wireless communication connection of the second wireless communication system is successful.

In a method for controlling a wireless communication device according to the present disclosure, the method includes: establishing a wireless communication connection of a first wireless communication system using setting information; searching for at least one other wireless communication device according to an NAN standard and establishing, with the at least one other wireless communication device, a wireless communication connection of a second wireless communication system different from the first wireless communication system, the second wireless communication system being a communication system according to the NAN standard; performing control to transmit the setting information to the at least one other wireless communication device using the wireless communication connection of the second wireless communication system; and disconnecting the wireless communication connection of the second wireless communication system to the other wireless communication device when the other wireless communication device successfully establishes the wireless communication connection of the first wireless communication system.

In a method for controlling a wireless communication device according to the present disclosure, the method includes: establishing, with other wireless communication device, a wireless communication connection of a first wireless communication system according to an NAN standard; acquiring setting information from the other wireless communication device using the wireless communication connection of the first wireless communication system; establishing a wireless communication connection of a second wireless communication system different from the first wireless communication system using the setting information; and disconnecting the wireless communication connection of the first wireless communication system when the establishment of the wireless communication connection of the second wireless communication system is successful.

A non-transitory computer-readable storage medium stores a program according to the present disclosure, the program causing a computer to execute: a first communication processing step of establishing a wireless communication connection of a first wireless communication system using setting information; a second communication processing step of searching for at least one other wireless communication device according to an NAN standard and establishing, with the at least one other wireless communication device, a wireless communication connection of a second wireless communication system different from the first wireless communication system, the second wireless communication system being a communication system according to the NAN standard; a transmission control step of performing control to transmit the setting information to the at least one other wireless communication device using the wireless communication connection of the second wireless communication system; and a disconnection step of disconnecting the wireless communication connection of the second wireless communication system to the other wireless communication device when the other wireless communication device successfully establishes the wireless communication connection of the first wireless communication system.

A non-transitory computer-readable storage medium stores a program according to the present disclosure, the program causing a computer to execute: a first communication processing step of establishing, with other wireless communication device, a wireless communication connection of a first wireless communication system according to an NAN standard; a setting information acquisition step of acquiring setting information from the other wireless communication device using the wireless communication connection of the first wireless communication system; a second communication processing step of establishing a wireless communication connection of a second wireless communication system different from the first wireless communication system using the setting information; and a disconnection step of disconnecting the wireless communication connection of the first wireless communication system when the establishment of the wireless communication connection of the second wireless communication system is successful.

### BRIEF DESCRIPTION OF THE DRAWINGS

FIG. 1 is a schematic diagram showing an example of a configuration of a communication system according to an embodiment.

FIG. 2 is a block diagram showing an example of a configuration of a wireless communication device according to the embodiment.

FIG. 3 is a block diagram showing an example of the configuration of the wireless communication device according to the embodiment.

FIG. 4A is a flowchart showing an example of an operation flow of the communication system for causing the wireless communication device to participate in a wireless LAN.

FIG. 4B is a flowchart showing an example of the operation flow of the communication system for causing the wireless communication device to participate in the wireless LAN.

FIG. 5 is a schematic diagram showing an example of a user interface screen.

FIG. 6 is a schematic diagram showing a disconnection of an NAN connection.

### DESCRIPTION OF EMBODIMENTS

Hereinafter, an embodiment will be described with reference to the drawings. To clarify the description, the following description and drawings are omitted and simplified as appropriate. In the drawings, the same elements are denoted by the same reference signs, and the redundant description thereof is omitted as necessary.

As described above, there is a demand for a technique for reducing an amount of processing for establishing a wireless communication connection. Here, in the embodiment, a technique is described in which it is possible to prevent an increase in an amount of processing by devising a disconnection timing of a wireless communication connection used for transmission of setting information, even in a situation in which retransmission of the setting information is necessary.

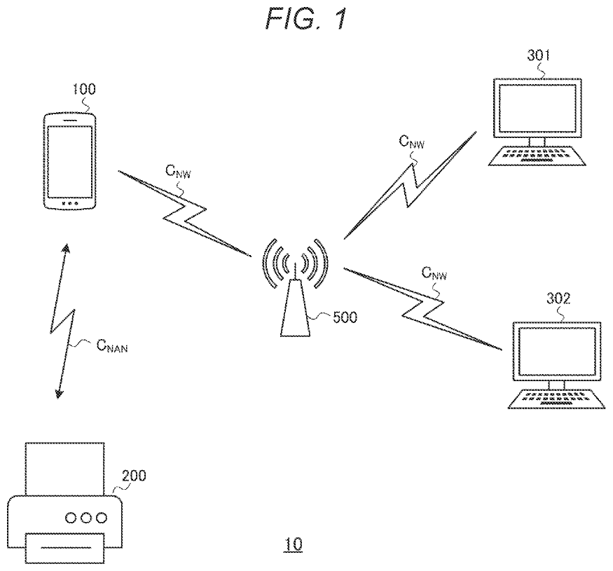

FIG. 1 is a schematic diagram showing an example of a configuration of a communication system 10 according to the embodiment. The communication system 10 includes an access point 500 and a plurality of wireless communication devices. The access point 500 is an access point of a wireless LAN. Specifically, the wireless LAN is, for example, a Wi-Fi (registered trademark) network. As shown in FIG. 1, the communication system 10 includes a wireless communication device 100 and a wireless communication device 200 as the plurality of wireless communication devices described above. In the embodiment, the wireless communication device 100 is a device that transmits setting information to be described later to the wireless communication device 200. The wireless communication device 200 is a device that receives the setting information from the wireless communication device 100 and connects to the wireless LAN using the setting information. In the example shown in FIG. 1, a wireless communication device 301 and a wireless communication device 302 are shown as other wireless communication devices connected by the wireless LAN. The communication system 10 may not necessarily include these wireless communication devices.

In the present disclosure, a wireless communication system for performing communication via the access point 500 is also referred to as a network (NW) wireless communication system. The NW wireless communication system can be referred to as a system for performing communication via the access point 500 according to a Wi-Fi (registered trademark) standard, or can be referred to as an infrastructure mode wireless communication system. In the present disclosure, a communication system according to the NAN standard is also referred to as an NAN wireless communication system. FIG. 1 shows a state in which the wireless communication device 100, the wireless communication device 301, and the wireless communication device 302 can execute communication C_{NW} of the NW wireless communication system. In the state shown in FIG. 1, the wireless communication connection of the NW wireless communication system is not yet established, and the wireless communication device 200 cannot execute the communication of the NW wireless communication system. Therefore, as described later, the wireless communication device 100 transmits the setting information to the wireless communication device 200 by communication C_{NAN} of the NAN wireless communication system.

In the embodiment, the wireless communication device 100 is, for example, a terminal device. Specifically, the wireless communication device 100 is, for example, a mobile terminal such as a smartphone or a tablet terminal. The wireless communication device 100 is not limited thereto, and may be a personal computer (PC) or the like. In the embodiment, the wireless communication device 200 is, for example, a printing device (printer). In the communication system 10, the wireless communication device 100 and the wireless communication device 200 perform communication of the NAN wireless communication system, that is, communication according to the NAN standard as described above.

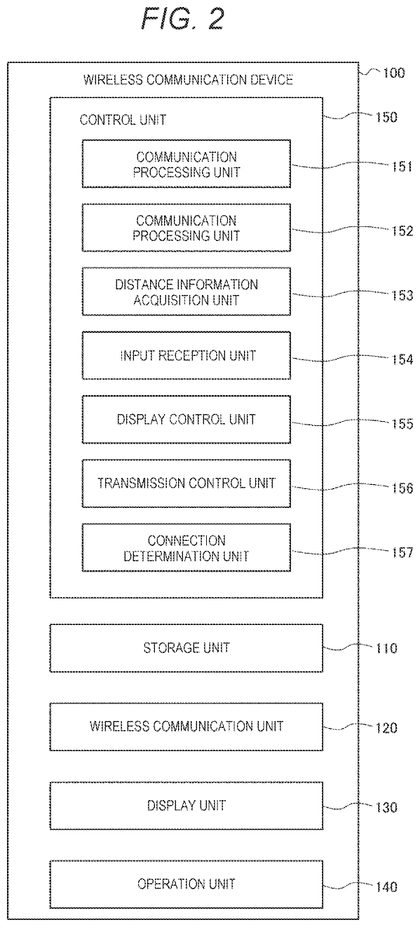

Hereinafter, specific configurations and processing of the wireless communication device 100 and the wireless communication device 200 will be described. First, the wireless communication device 100 will be described. FIG. 2 is a block diagram showing an example of the configuration of the wireless communication device 100. As shown in FIG. 2, the wireless communication device 100 includes a storage unit 110, a wireless communication unit 120, a display unit 130, an operation unit 140, and a control unit 150.

The storage unit 110 is a storage device that stores a program for implementing processing of the control unit 150 and data used for processing of the wireless communication device 100. The storage device may be a nonvolatile storage device such as a hard disk or a flash memory, or may include a memory such as a random access memory (RAM).

The wireless communication unit 120 is hardware that performs wireless communication. That is, the wireless communication unit 120 is a wireless communication interface. The wireless communication unit 120 may include a transmission circuit, a reception circuit, and an antenna.

The display unit 130 and the operation unit 140 are user interfaces. The display unit 130 is implemented by a display or the like that displays various types of information to the user. The operation unit 140 is implemented by a button or the like that receives an input operation from the user. The display unit 130 and the operation unit 140 may be integrally implemented by a touch panel or the like.

The control unit 150 is a processor such as a central processing unit (CPU) that controls each configuration of the wireless communication device 100. The control unit 150 may include a plurality of processors. The control unit 150 reads a program into the memory and executes the program. Accordingly, in the embodiment, the control unit 150 implements functions of a communication processing unit 151, a communication processing unit 152, a distance information acquisition unit 153, an input reception unit 154, a display control unit 155, a transmission control unit 156, and a connection determination unit 157.

The wireless communication device 100 includes the communication processing unit 151 and the communication processing unit 152, and has a configuration capable of performing communication in two types of different wireless communication systems.

The communication processing unit 151 performs processing of executing communication of the NW wireless communication system. The processing includes processing of establishing a wireless communication connection of the NW wireless communication system using setting information. The setting information is information necessary for establishing the wireless communication connection of the NW wireless communication system, that is, information for connecting to the wireless LAN. In the embodiment, specifically, the setting information is a service set identifier (SSID) and a password of the access point 500. The communication of the NW wireless communication system is performed after a wireless communication connection is established using such setting information.

The communication processing unit 152 performs processing of executing the communication of the NAN wireless communication system with at least one wireless communication device. The wireless communication device 100 and the wireless communication device 200 can perform two types of communication, that is, communication using a discovery window (DW) according to the NAN standard and communication performed after establishing the wireless communication connection according to the NAN standard, as the communication of the NAN wireless communication system. Therefore, the processing performed by the communication processing unit 152 includes processing of executing the communication using the discovery window and processing of executing the communication performed after establishing the wireless communication connection. Hereinafter, the wireless communication connection according to the NAN standard is also referred to as an NAN connection. Here, in the embodiment, the wireless communication connection according to the NAN standard is specifically an NAN data link. As described later, the communication processing unit 152 searches for at least one other wireless communication device according to the NAN standard, and establishes an NAN connection (NAN data link), which is a wireless communication connection of the NAN wireless communication system, with the at least one other wireless communication device.

Here, processing of the communication processing unit 151 and a communication processing unit 241 of the wireless communication device 200, which will be described later, for establishing an NAN connection between the wireless communication device 100 and the wireless communication device 200 will be described in detail. The communication processing unit 241 is a component of the wireless communication device 200 that performs processing of executing the communication of the NAN wireless communication system. The communication processing unit 151 and the communication processing unit 241 of the wireless communication device 200 to be described later establish an NAN connection according to a connection sequence defined by the NAN standard.

In order to establish the NAN connection, first, the communication processing unit 152 of the wireless communication device 100 and the communication processing unit 241 of the wireless communication device 200 perform processing for implementing an NAN cluster by the wireless communication device 100 and the wireless communication device 200. Thereafter, the communication processing unit 152 of the wireless communication device 100 and the communication processing unit 241 of the wireless communication device 200 perform processing of constructing the NAN connection, that is, the NAN data link.

In the NAN standard, a period called a discovery window is defined. The discovery window is mainly a communication period that occurs intermittently for the device to perform service notification and search, and arrives at a predetermined cycle. A set of devices sharing the discovery window is called an NAN cluster. A device operating as a master transmits a discovery beacon for recognizing the NAN cluster to another device that does not yet belong to the NAN cluster. The device operating as the master transmits a synchronization beacon for each device to synchronize with the discovery window. In the embodiment, the wireless communication device 100 may operate as a master, or the wireless communication device 200 may operate as a master.

Each device implementing the NAN cluster can confirm a service provided by each device by transmitting and receiving a signal in the discovery window. Specifically, in the discovery window, a signal implemented by a frame of a format called a service discovery frame is transmitted.

A device implementing an NAN cluster can establish a data link capable of intercommunicating with another device implementing the NAN cluster regardless of a DW period. That is, the NAN connection can be established between devices implementing the NAN cluster. In the NAN standard, the above-described data link is called an NAN data link. Hereinafter, a flow until the wireless communication device 100 and the wireless communication device 200 perform the NAN connection in the embodiment will be described.

First, the wireless communication device 100 and the wireless communication device 200 share the discovery window. In order to share the discovery window, either the wireless communication device 100 or the wireless communication device 200 operates as a master. For example, when the wireless communication device 100 operates as a master, the communication processing unit 152 of the wireless communication device 100 performs processing of transmitting a discovery beacon and a synchronization beacon from the wireless communication device 100.

When the wireless communication device 100 and the wireless communication device 200 share the discovery window, the wireless communication device 200 waits for an inquiry about a service to be broadcast. Then, the communication processing unit 152 of the wireless communication device 100 performs communication using the discovery window in order to search for the wireless communication device 200 which is a device providing a specific service (in the embodiment, for example, a printing service). Specifically, the communication processing unit 152 broadcasts the inquiry about the service by transmitting a signal using the discovery window defined in the NAN standard. That is, the communication processing unit 152 broadcasts a message for making an inquiry to all other devices implementing the NAN cluster. The message is a message using the service discovery frame. In response, the communication processing unit 241 of the wireless communication device 200 that received the broadcast of the inquiry responds to the inquiry by transmitting a signal using the discovery window defined by the NAN standard. Accordingly, the wireless communication device 100 can specify a device capable of providing the specific service. Thereafter, the communication processing unit 152 of the wireless communication device 100 and the communication processing unit 241 of the wireless communication device 200 execute processing of establishing the NAN data link according to a connection procedure according to the NAN standard. Accordingly, the NAN connection is established.

Next, another processing of the communication processing unit 152 of the wireless communication device 100 will be described. The communication processing unit 152 also performs processing of disconnecting the NAN connection, that is, processing of ending the NAN connection. In particular, when a wireless communication device (wireless communication device 200) as a transmission destination of the setting information transmitted under the control of the transmission control unit 156 to be described later successfully establishes the wireless communication connection of the NW wireless communication system, the communication processing unit 152 disconnects the wireless communication connection of the NAN wireless communication system to the wireless communication device (wireless communication device 200). That is, after the wireless communication device 200 that received the setting information successfully connects to the wireless LAN (access point 500), the communication processing unit 152 disconnects the NAN connection with the wireless communication device 200. In this case, the communication processing unit 152 may not only disconnect the NAN connection but also separate the wireless communication device 100 from the NAN cluster to which the wireless communication device 100 belongs in order to establish the NAN connection. Here, the separation from the NAN cluster is specifically the end of processing of synchronizing with the discovery window, that is, the end of NAN synchronization. When the wireless communication device 100 transmits the setting information to a plurality of wireless communication devices 200, the communication processing unit 152 may disconnect only the NAN connection to the wireless communication device 200, which successfully establishes the wireless communication connection of the NW wireless communication system, among the plurality of wireless communication devices 200. In this case, the communication processing unit 152 may separate the wireless communication device 100 from the NAN cluster when all the wireless communication devices 200 belonging to the same NAN cluster, which are the transmission destinations of the setting information, successfully establish the wireless communication connection of the NW wireless communication system. It is possible to reduce power consumption due to execution of unnecessary communication by disconnecting the NAN connection or separating the wireless communication device 100 from the NAN cluster. When a common antenna is used in the communication of the NW wireless communication system and the communication of the NAN wireless communication system, it is possible to improve throughput of the communication of the NW wireless communication system by disconnecting the NAN connection or separating the wireless communication device 100 from the NAN cluster.

The distance information acquisition unit 153 acquires, for each wireless communication device found by a search according to the NAN standard, distance information indicating a distance to the wireless communication device 100. That is, the distance information acquisition unit 153 acquires information indicating a distance between the wireless communication device 100 and another wireless communication device belonging to the NAN cluster to which the wireless communication device 100 belongs. In the embodiment, the distance information acquisition unit 153 acquires the distance information indicating the distance to the wireless communication device 100 measured according to the NAN standard. The NAN standard defines a technique in which a device implementing an NAN cluster measures a distance between the device and another device implementing the NAN cluster. The technique is also called Ranging. In Ranging, a predetermined frame is transmitted and received between the devices implementing the NAN cluster, and a distance between the devices is calculated based on a transmission and reception time of the predetermined frame. The distance information acquisition unit 153 acquires the distance between the wireless communication device 100 and another wireless communication device (the wireless communication device 200 or the like) measured using the technique. The distance information acquisition unit 153 may acquire the distance information indicating the distance measured by the wireless communication device 100, or may acquire, from the other wireless communication device, information indicating a distance measured by the other wireless communication device. In the embodiment, the distance information acquisition unit 153 acquires the distance measured according to the NAN standard, and may acquire a distance measured according to another technique. In this case, the distance information acquired by the distance information acquisition unit 153 may be information indicating the distance measured by the wireless communication device 100 or information indicating a distance received from another device.

The input reception unit 154 receives an instruction or information input by the user via the operation unit 140. In the embodiment, for example, the input reception unit 154 receives a printing instruction given by the user via the operation unit 140. The instruction includes an instruction to designate data to be printed. The instruction may further include an instruction to designate a print setting. The input reception unit 154 receives an instruction as to whether to connect another wireless communication device (the wireless communication device 200) to the wireless LAN. The input reception unit 154 may receive an instruction to select a wireless communication device to be connected to the wireless LAN. That is, the input reception unit 154 may receive an instruction to select a wireless communication device as a transmission destination of the setting information for connecting to the wireless LAN.

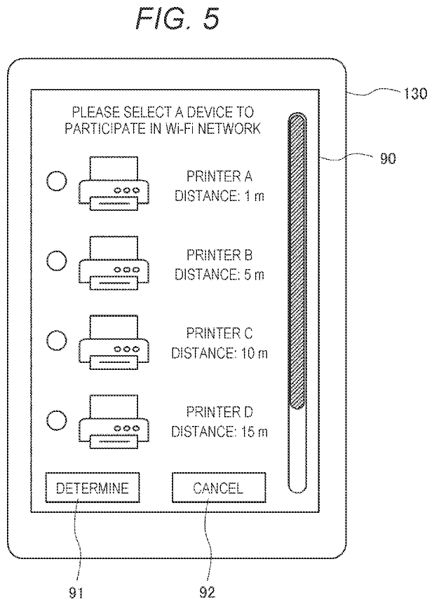

The display control unit 155 controls display performed by the display unit 130. In the embodiment, the display control unit 155 displays, on the display unit 130, a user interface screen for determining a wireless communication device as a transmission destination of the setting information as shown in FIG. 5 to be described later. That is, the display control unit 155 controls the display unit 130 to display a list of wireless communication devices found by a search according to the NAN standard. In particular, the display control unit 155 controls the display unit 130 to display distance information for each wireless communication device acquired by the distance information acquisition unit 153. That is, the display control unit 155 performs control such that the distance information for each wireless communication device is also displayed in the list described above. Accordingly, the user can select a wireless communication device to be connected to the wireless LAN with reference to the distance. Therefore, convenience for the user is improved.

The transmission control unit 156 performs control to transmit setting information necessary for establishing the wireless communication connection of the NW wireless communication system to at least one other wireless communication device found by a search according to the NAN standard, by using the wireless communication connection of the NAN wireless communication system established by the communication processing unit 152, that is, the NAN connection. Accordingly, in the embodiment, the setting information (the SSID and the password of the access point 500) is transmitted to the wireless communication device 200. When the wireless communication device (wireless communication device 200) as the transmission destination of the setting information does not successfully establish the wireless communication connection of the NW wireless communication system after the transmission of the setting information, the transmission control unit 156 may perform control to transmit the setting information to the wireless communication device again using the wireless communication connection of the NAN wireless communication system in which the connection is maintained. That is, when the wireless communication device 200 that received the setting information fails to connect to the wireless LAN (access point 500), the wireless communication device 100 may transmit the setting information to the wireless communication device 200 again. As described above, by performing the retransmission of the setting information, it is possible to appropriately transmit the setting information even when an error occurs in the first transmission of the setting information. That is, even when a bit error occurs due to an influence of noise or the like during the transmission of the setting information, since the setting information is retransmitted to the wireless communication device 200, the wireless communication device 200 can receive correct setting information. In particular, in the embodiment, the NAN connection is not immediately disconnected after the transmission of the setting information, and the NAN connection is maintained. Therefore, even when retransmission of the setting information is necessary, processing of establishing the NAN connection again is not necessary. Therefore, the setting information can be immediately retransmitted. The transmission control unit 156 may transmit, to the wireless communication device 200, the setting information and a request for instructing execution of connection processing using the setting information.

The transmission control unit 156 may limit, based on the distance information acquired by the distance information acquisition unit 153, a transmission destination of the setting information necessary for establishing the wireless communication connection of the NW wireless communication system. For example, the transmission control unit 156 may perform control to transmit the setting information only to a wireless communication device existing within a predetermined distance from the wireless communication device 100. Accordingly, it is possible to prevent the setting information from being transmitted to the wireless communication device located at a far position, and thus it is possible to prevent the setting information from leaking to the wireless communication device which is not managed by the user. According to the above-described configuration, since the setting information is transmitted to the wireless communication device 200 which is closest to the user of the wireless communication device 100, it is possible to implement printing via the wireless LAN by a device closest to the user.

The transmission control unit 156 may determine a transmission destination of the setting information according to an instruction to select the transmission destination from the wireless communication devices listed in the above-described list displayed by the display control unit 155. In this case, the transmission control unit 156 determines the transmission destination of the setting information according to the instruction from the user received by the input reception unit 154. According to such a configuration, the user can select a transmission destination of the setting information from the list. That is, the user can select a wireless communication device to be connected to the wireless LAN. Therefore, convenience for the user is improved.

The transmission control unit 156 may control transmission of information other than the setting information. For example, the transmission control unit 156 may perform control to transmit a print job generated according to a printing instruction received by the input reception unit 154 to the wireless communication device 200 using the wireless communication connection of the NW wireless communication system or the NAN wireless communication system. The transmission control unit 156 may perform control to switch the wireless communication connection between the NW wireless communication system and the NAN wireless communication system according to the throughput, and to transmit the print job. In particular, when the wireless communication device 200 that received the setting information fails to establish the wireless communication connection of the NW wireless communication system, the transmission control unit 156 may perform control to transmit the print job to the wireless communication device 200 using the wireless communication connection of the NAN wireless communication system. According to such a configuration, even when the wireless communication device 100 and the wireless communication device 200 cannot perform communication of the NW wireless communication system, printing can be implemented.

After the wireless communication device 200 that received the setting information succeeds in the wireless communication connection of the NW wireless communication system, the wireless communication connection may be disconnected for some reason such as a failure or replacement of the access point 500 or a change in a radio wave environment. That is, the wireless communication connection of the NW wireless communication system of the wireless communication device 200 may be disconnected in a state in which the NAN connection between the wireless communication device 100 and the wireless communication device 200 is not maintained. In such a case, that is, when the wireless communication connection is disconnected after the establishment of the wireless communication connection of the NW wireless communication system by the wireless communication device 200 is successful, the wireless communication device 100 may operate as follows. First, the communication processing unit 152 performs processing of establishing an NAN connection with the wireless communication device 200 again. Thereafter, the transmission control unit 156 performs control to transmit the print job to the wireless communication device 200 using the re-established NAN connection. According to such a configuration, even when the wireless communication device 100 and the wireless communication device 200 cannot perform communication of the NW wireless communication system, printing can be implemented.

The connection determination unit 157 determines whether the wireless communication device 200 successfully connects to the wireless LAN (access point 500). In the embodiment, as an example, the connection determination unit 157 determines whether the connection is successful by determining whether the wireless communication device 100 receives a packet from the wireless communication device 200 by the communication of the NW wireless communication system. When the wireless communication device 100 received the packet from the wireless communication device 200 by the communication of the NW wireless communication system, the connection determination unit 157 determines that the connection is successful. In contrast, for example, when the network connection performed by the wireless communication device 200 cannot be confirmed even after a predetermined time elapses from the transmission of the setting information, the connection determination unit 157 determines that the wireless communication device 200 fails in the network connection. That is, when the wireless communication device 100 cannot receive the packet from the wireless communication device 200 even after the predetermined time elapses from the transmission of the setting information, the connection determination unit 157 determines that the wireless communication device 200 fails in the network connection. The connection determination unit 157 may perform the following processing in order to obtain the packet from the wireless communication device 200. For example, the connection determination unit 157 may broadcast a packet for searching for the wireless communication device 200 to each device connected to the wireless LAN (access point 500) using the communication of the NW wireless communication system. Then, when the wireless communication device 100 received, by the communication of the NW wireless communication system, a response packet from the wireless communication device 200 that received the packet, the connection determination unit 157 determines that the wireless communication device 200 successfully connects to the wireless LAN. In contrast, when the wireless communication device 100 cannot receive the response packet, the connection determination unit 157 determines that the wireless communication device 200 fails to connect to the wireless LAN. The above-described packet for searching for the wireless communication device 200 may be periodically transmitted, or may be transmitted at a predetermined timing after the transmission of the setting information.

Identity between a wireless communication device as a transmission destination of the setting information and a wireless communication device as a transmission source of the packet such as the above-described response packet can be determined by using, for example, a media access control (MAC) address notified during communication. In this case, the connection determination unit 157 may store, in the storage unit 110, an MAC address of a wireless communication device as a transmission destination notified in the communication for transmitting the setting information. Then, the connection determination unit 157 determines whether the connection of the wireless communication device 200 to the wireless LAN is successful by determining whether the MAC address notified by the communication of the NW wireless communication system matches the MAC address stored in a storage unit 210.

The above-described determination method of the connection is an example, and the wireless communication device 100 does not necessarily broadcast the packet for searching for the wireless communication device 200. For example, when the wireless communication device 200 establishes the wireless communication connection of the NW wireless communication system, the wireless communication device 200 may broadcast the packet to each device connected to the wireless LAN (access point 500) using the communication of the NW wireless communication system. In this case, the wireless communication device 100 does not need to broadcast the packet for searching for the wireless communication device 200. The broadcast of the packet performed by the wireless communication device that establishes the wireless communication connection of the NW wireless communication system may be performed at a time when the wireless communication connection is established, or may be performed periodically. The broadcast may be performed not only by the wireless communication device 200 but also by any wireless communication device that establishes the wireless communication connection of the NW wireless communication system. The connection determination unit 157 may also determine whether the wireless communication device 100 is connected to the wireless LAN (access point 500).

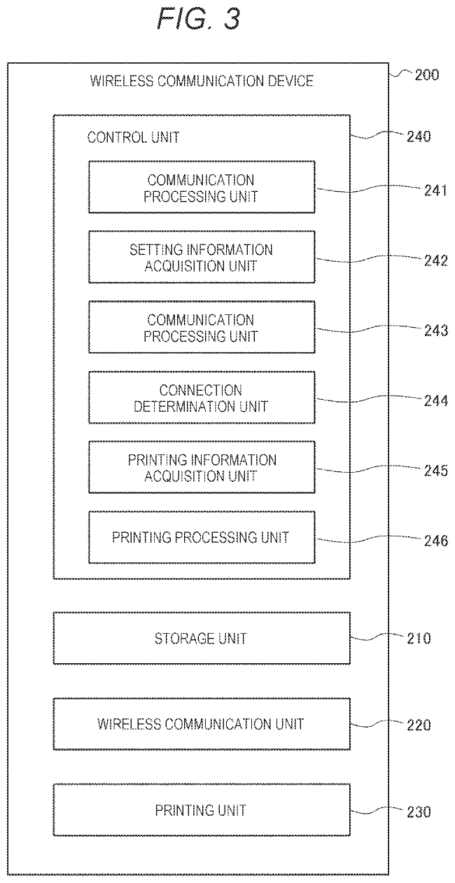

Next, the wireless communication device 200 will be described. FIG. 3 is a block diagram showing an example of a configuration of the wireless communication device 200. As shown in FIG. 3, the wireless communication device 200 includes the storage unit 210, a wireless communication unit 220, a printing unit 230, and a control unit 240. The wireless communication device 200 may include other components. For example, the wireless communication device 200 may further include a user interface such as a touch panel display, or may further include a scanner.

The storage unit 210 is a storage device that stores a program for implementing processing of the control unit 240 and data used for processing of the wireless communication device 200. The storage device may be a nonvolatile storage device such as a hard disk or a flash memory, and may include a memory such as an RAM.

The wireless communication unit 220 is hardware that performs wireless communication. That is, the wireless communication unit 220 is a wireless communication interface. The wireless communication unit 220 may include a transmission circuit, a reception circuit, and an antenna.

The printing unit 230 has a printing function for printing on a printing medium such as a sheet. The printing unit 230 includes a printing engine. The printing engine is a mechanical configuration that prints an image on the printing medium using a color material. The printing engine may include a mechanism for printing using ink by, for example, an inkjet method. Alternatively, the printing engine may include a mechanism for printing using toner by, for example, electrophotography. The printing engine may include a transport mechanism for transporting the printing medium.

The control unit 240 is a processor such as a CPU that controls each configuration of the wireless communication device 200. The control unit 240 may include a plurality of processors. The control unit 240 reads a program into the memory and executes the program. Accordingly, in the embodiment, the control unit 240 implements functions of the communication processing unit 241, a setting information acquisition unit 242, a communication processing unit 243, a connection determination unit 244, a printing information acquisition unit 245, and a printing processing unit 246.

The wireless communication device 200 includes the communication processing unit 241 and the communication processing unit 243, and has a configuration capable of performing communication in two types of different wireless communication systems.

The communication processing unit 241 performs processing of executing communication of the NAN wireless communication system with another wireless communication device (in the embodiment, the wireless communication device 100). As described above, the wireless communication device 100 and the wireless communication device 200 can perform two types of communication, that is, communication using the discovery window and communication performed after establishing an NAN connection, as communication of the NAN wireless communication system. Therefore, the processing performed by the communication processing unit 241 includes processing of executing the communication using the discovery window and processing of executing the communication performed after establishing the NAN connection. As described above, in the embodiment, the communication processing unit 241 performs the communication with the wireless communication device 100 using the discovery window to establish an NAN connection with the wireless communication device 100. The communication processing unit 241 may also establish an NAN connection with a wireless communication device, for example, the wireless communication device 301 or the wireless communication device 302, other than the wireless communication device 100.

The communication processing unit 241 also performs processing of disconnecting the NAN connection, that is, processing of ending the NAN connection. In particular, the communication processing unit 241 disconnects the NAN connection established with the wireless communication device 100 when the wireless communication connection of the NW wireless communication system is successfully established. That is, the communication processing unit 241 disconnects the NAN connection with the wireless communication device 100 when connection processing performed by the communication processing unit 243 to be described later using the setting information received from the wireless communication device 100 is successful. In other words, the communication processing unit 241 disconnects the NAN connection with the wireless communication device 100 after the wireless communication device 200 successfully connects to the wireless LAN (access point 500). The communication processing unit 241 may not only disconnect the NAN connection but also separate the wireless communication device 200 from the NAN cluster to which the wireless communication device 200 belongs in order to establish the NAN connection.

As described above, the wireless communication device 200 may also establish an NAN connection with a wireless communication device (for example, the wireless communication device 301 or 302) other than the wireless communication device 100. In this case, the communication processing unit 241 may also disconnect the NAN connection with the wireless communication device capable of communicating via the wireless communication connection of the NW wireless communication system. That is, when the wireless communication connection of the NW wireless communication system is successfully established, the communication processing unit 241 may perform the following disconnection processing in addition to the disconnection processing of the NAN connection with the wireless communication device 100 as the transmission source of the setting information. The communication processing unit 241 also disconnects the NAN connection to a device other than the wireless communication device 100 and capable of communicating via the wireless communication connection of the NW wireless communication system that is successfully established, among the other devices that are establishing the NAN connection with the wireless communication device 100.

The setting information acquisition unit 242 acquires setting information from the wireless communication device 100 using the wireless communication connection of the NAN wireless communication system established by the communication processing unit 241, that is, the NAN connection.

The communication processing unit 243 performs processing of executing communication of the NW wireless communication system. The communication processing unit 243 establishes a wireless communication connection of the NW wireless communication system using the setting information acquired by the setting information acquisition unit 242, that is, the setting information received from the wireless communication device 100. Specifically, the communication processing unit 243 establishes the wireless communication connection of the NW wireless communication system using the SSID and the password of the access point 500 received from the wireless communication device 100. When the wireless communication connection of the NW wireless communication system is successfully established, the communication processing unit 241 disconnects the NAN connection as described above.

The connection determination unit 244 determines whether the wireless communication device 200 establishes the wireless communication connection of the NW wireless communication system. That is, the connection determination unit 244 determines whether the wireless communication device 200 successfully connects to the wireless LAN (access point 500). The connection determination unit 244 determines whether there is a device capable of wireless communication of the NW wireless communication system among the other devices that are establishing the NAN connection with the wireless communication device 200. For example, the connection determination unit 244 performs the determination by the same processing as that of the connection determination unit 157 described above. That is, the connection determination unit 244 determines whether the wireless communication device 200 receives, by the communication of the NW wireless communication system, a packet from the wireless communication device that is establishing the NAN connection. That is, when the same MAC address as the MAC address acquired by the communication using the NAN connection is acquired by the communication of the NW wireless communication system, the connection determination unit 244 determines that there is a wireless communication device that establishes the NAN connection with the wireless communication device 200 and can perform the wireless communication of the NW wireless communication system with the wireless communication device 200.

The printing information acquisition unit 245 acquires a print job from the wireless communication device 100 using the NAN connection established by the communication processing unit 241 or the wireless communication connection of the NW wireless communication system established by the communication processing unit 243.

The printing processing unit 246 performs processing for executing printing by the printing unit 230. In the embodiment, the printing processing unit 246 executes, using the printing unit 230, printing according to the print job received from the wireless communication device 100.

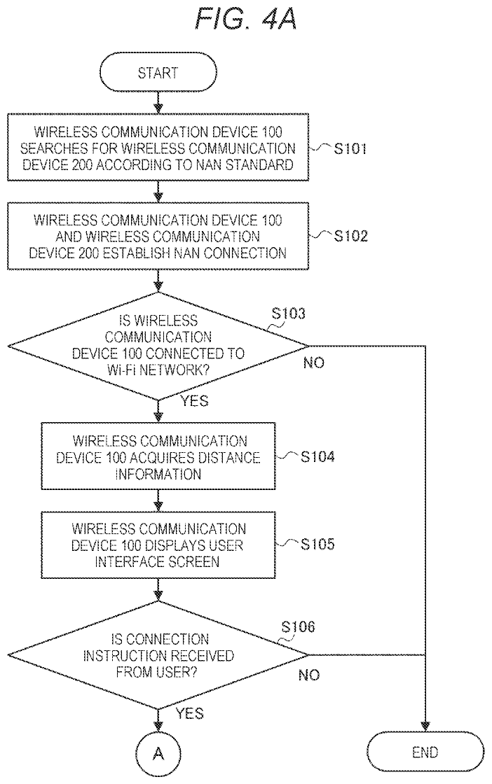

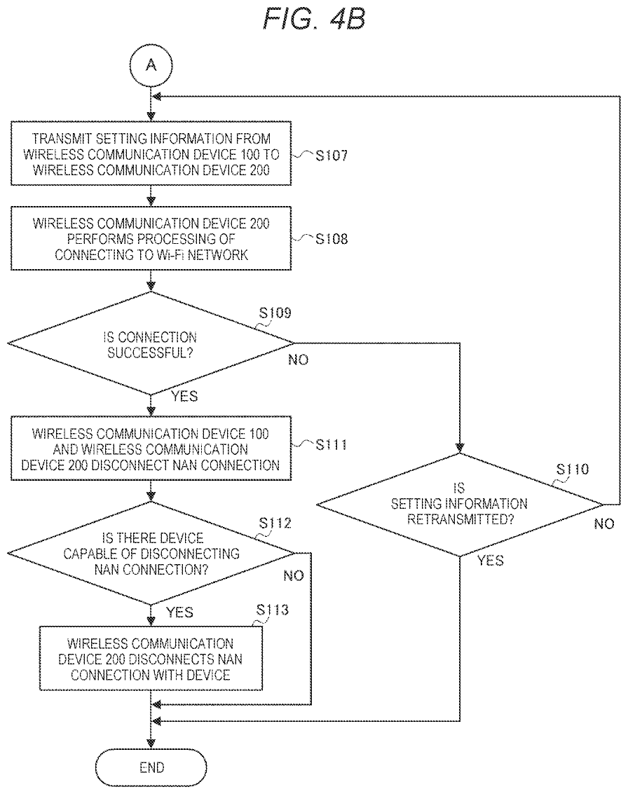

Next, in the embodiment, an operation flow of the communication system 10 for causing the wireless communication device 200 to participate in the wireless LAN will be described. FIGS. 4A and 4B are flowcharts showing an example of the operation flow of the communication system 10 for causing the wireless communication device 200 to participate in the wireless LAN in the embodiment. The flowcharts shown in FIGS. 4A and 4B are merely shown an example of the operation. Accordingly, for example, an execution order of steps can be changed as long as there is no technical contradiction. Some of the steps may be omitted. Prior to the operation described below, the wireless communication device 100 establishes the wireless communication connection of the NW wireless communication system using the setting information. On the other hand, it is assumed that the wireless communication device 200 has not yet established the wireless communication connection of the NW wireless communication system. Hereinafter, the operation flow will be described with reference to FIGS. 4A and 4B.

In step S101, the communication processing unit 152 of the wireless communication device 100 searches for the wireless communication device 200 according to the NAN standard by broadcasting an inquiry about a service. That is, the communication processing unit 152 performs communication using a discovery window, and searches for the wireless communication device 200. At this time, the communication processing unit 152 may search for only a wireless communication device capable of providing a specific service according to the NAN standard by broadcasting the inquiry about the service. In this case, in the subsequent step, the setting information is transmitted only to the wireless communication device capable of providing the specific service. Accordingly, it is possible to search for only a wireless communication device appropriate for participation in the wireless LAN. For example, the communication processing unit 152 may search for a device capable of providing a connection service such as the wireless communication device 200, that is, only a wireless communication device having a function of establishing the wireless communication connection of the NW wireless communication system using the setting information received by the NAN connection. For example, the communication processing unit 152 may search for only a wireless communication device capable of providing a printing service, or may search for only a wireless communication device capable of providing a scan service. The communication processing unit 152 may search for only a wireless communication device capable of providing a specific service satisfying a specific condition. For example, the communication processing unit 152 may search for only a wireless communication device capable of providing a printing service with a specific print setting.

Then, in the embodiment, in step S102, the communication processing unit 152 of the wireless communication device 100 establishes an NAN connection with the wireless communication device 200. In other words, the communication processing unit 241 of the wireless communication device 200 establishes the NAN connection with the wireless communication device 100. When the plurality of wireless communication devices 200 are found in the search in step S101, the communication processing unit 152 of the wireless communication device 100 may establish an NAN connection with the plurality of wireless communication devices 200.

Next, in step S103, the connection determination unit 157 of the wireless communication device 100 determines whether the wireless communication device 100 is connected to a wireless LAN (specifically, a Wi-Fi (registered trademark) network in the embodiment). Here, the description is continued assuming that the wireless communication device 100 is connected to the wireless LAN. However, when the wireless communication device 100 is not connected to the wireless LAN, the processing ends. When the wireless communication device 100 is connected to the wireless LAN, the processing proceeds to step S104. When the wireless communication device 100 stores the setting information, the processing may proceed to step S104 regardless of whether the wireless communication device 100 is connected to the wireless LAN.

In step S104, the distance information acquisition unit 153 of the wireless communication device 100 acquires a distance between the wireless communication device 100 and another wireless communication device for which the NAN connection is established in step S102.

Next, in step S105, the display control unit 155 of the wireless communication device 100 displays, on the display unit 130, a user interface screen for determining the wireless communication device as the transmission destination of the setting information. Specifically, for example, as shown in FIG. 5, the display control unit 155 displays, on the display unit 130, a user interface screen 90 including a list of wireless communication devices found by the search in step S101. That is, the display control unit 155 displays, on the display unit 130, a list in which candidates of the wireless communication device as the transmission destination of the setting information are shown.

FIG. 5 is a schematic diagram showing an example of the user interface screen 90 displayed by the display control unit 155. As shown in FIG. 5, the display control unit 155 may display, for each candidate as the transmission destination of the setting information, a distance from the wireless communication device 100. As shown in FIG. 5, the display control unit 155 may display identification information (printer name) on each wireless communication device. In order to acquire the identification information on each wireless communication device, an inquiry about the identification information may be made to the NAN connected wireless communication device. The user interface screen 90 shown in FIG. 5 includes a button 91 for instructing transmission of the setting information stored by the wireless communication device 100 to another wireless communication device, and a button 92 for canceling the transmission of the setting information stored by the wireless communication device 100 to another wireless communication device. The button 91 can also be referred to as a button for instructing the other wireless communication device to newly participate in the wireless LAN. The button 92 can also be referred to as a button for canceling the other wireless communication device to newly participate in the wireless LAN. When the user causes the other wireless communication device to newly participate in the wireless LAN, the user selects a participation target device from the wireless communication devices listed in the list, and presses the button 91. In the example shown in FIG. 5, the user interface screen 90 includes the list, but a user interface screen not including the list may be displayed. In this case, when the user causes the other wireless communication device to newly participate in the wireless LAN, the user instructs the other wireless communication device to newly participate in the wireless LAN without selecting a wireless communication device. In this case, the transmission control unit 156 may transmit the setting information to all the NAN connected wireless communication devices, or may determine the wireless communication device as the transmission destination based on the distance information as described above.

When the input reception unit 154 receives, from the user, an instruction to cause the other wireless communication device to connect to the wireless LAN (YES in step S106), that is, when the button 91 is operated, the processing proceeds to step S107. When the instruction to cause the other wireless communication device to connect to the wireless LAN is not received (NO in step S106), that is, when the button 92 is operated, the processing ends.

In step S107, the transmission control unit 156 of the wireless communication device 100 performs control to transmit, to the wireless communication device 200, the setting information for establishing the wireless communication connection of the NW wireless communication system, that is, the setting information for connecting to the Wi-Fi (registered trademark) network, using the NAN connection established in step S102. For example, the transmission control unit 156 performs control to transmit the setting information to the wireless communication device 200 selected by the user as the transmission destination among the wireless communication devices 200 listed in the list. In response, the setting information acquisition unit 242 of the wireless communication device 200 acquires the setting information transmitted from the wireless communication device 100. Accordingly, the setting information is transmitted from the wireless communication device 100 to the wireless communication device 200 via the NAN connection.

Next, in step S108, the communication processing unit 243 of the wireless communication device 200 executes processing of establishing a wireless communication connection of the NW wireless communication system using the setting information received from the wireless communication device 100. That is, the communication processing unit 243 executes processing for connecting to the Wi-Fi (registered trademark) network. When the wireless communication device 200 establishes the wireless communication connection of the NW wireless communication system, that is, when the connection to the Wi-Fi (registered trademark) network is successful (YES in step S109), the processing proceeds to step S111. In contrast, when the connection fails (NO in step S109), the processing proceeds to step S110. The success or failure of a network connection performed by the wireless communication device 200 is detected by the connection determination unit 157 of the wireless communication device 100 and the connection determination unit 244 of the wireless communication device 200.

In step S110, the transmission control unit 156 of the wireless communication device 100 determines whether the setting information is already retransmitted to the wireless communication device 200 for which the network connection fails. When the setting information is not retransmitted (NO in step S110), the processing returns to step S107. Then, in step S107, the setting information is retransmitted. Accordingly, even when an error occurs in the first transmission of the setting information, the setting information can be appropriately transmitted to the wireless communication device 200. In contrast, when the setting information is already retransmitted (YES in step S110), the processing ends. For example, when a distance between the wireless communication device 200 and the access point 500 is long and a radio wave is weak, the determination in step S110 is YES.

When the processing proceeds to step S111, in step S111, the communication processing unit 241 of the wireless communication device 200 and the communication processing unit 152 of the wireless communication device 100 disconnect the NAN connection. Disconnection processing of the NAN connection may be performed by only one of the wireless communication device 200 and the wireless communication device 100. After step S111, the processing proceeds to step S112.

In step S112, the connection determination unit 244 of the wireless communication device 200 determines whether there is a wireless communication device that is establishing an NAN connection with the wireless communication device 200 and is accessible via the Wi-Fi (registered trademark) network. That is, the connection determination unit 244 determines whether there is a wireless communication device capable of disconnecting the NAN connection. When there is a wireless communication device capable of disconnecting the NAN connection (YES in step S112), the processing proceeds to step S113. When there is no wireless communication device capable of disconnecting the NAN connection (NO in step S112), the processing ends.

In step S113, the communication processing unit 241 of the wireless communication device 200 disconnects the NAN connection with a wireless communication device found as the wireless communication device that can be disconnected in step S112. Thereafter, the processing ends. In the flowchart described above, the distance information is acquired after step S102, but may be acquired before step S102. In this case, the communication processing unit 152 may limit, using the distance information, a partner for which the NAN connection is established. That is, for example, the communication processing unit 152 may establish an NAN connection with a wireless communication device whose distance is equal to or less than a predetermined threshold.

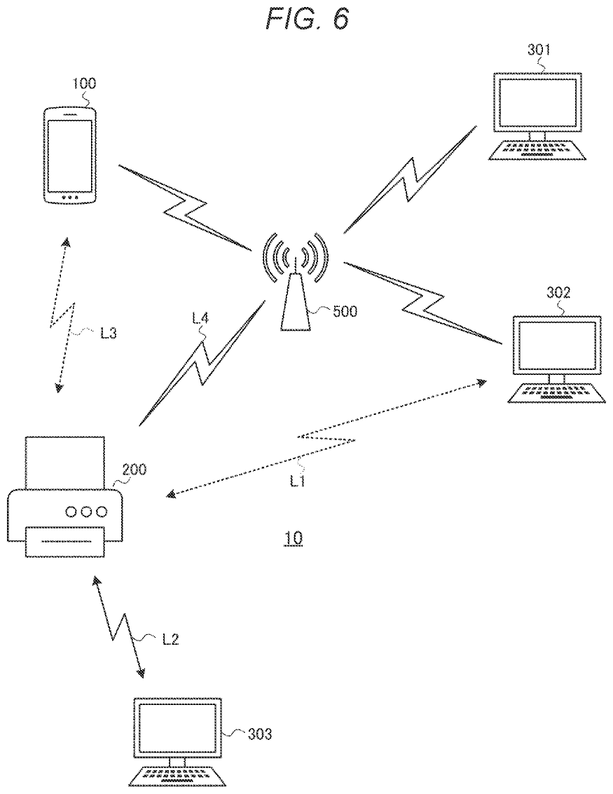

FIG. 6 is a schematic diagram showing a disconnection of an NAN connection. In the example shown in FIG. 6, it is assumed that before step S101 described above is started, the wireless communication device 200 already establishes an NAN connection L1 with the wireless communication device 302 and already establishes an NAN connection L2 with a wireless communication device 303. It is assumed that the wireless communication device 303 is a device not connected to the wireless LAN. Then, in step S102, the wireless communication device 200 also establishes an NAN connection L3 with the wireless communication device 100. Further, in step S108, the wireless communication device 200 establishes a wireless communication connection L4 of the NW wireless communication system. In this case, in step S111, the NAN connection L3 is disconnected. Since the wireless communication device 200 and the wireless communication device 302 can communicate with each other via the access point 500, the NAN connection L1 is disconnected in step S113. However, since the wireless communication device 200 cannot communicate with the wireless communication device 303 via the access point 500 still, the wireless communication device 200 maintains the NAN connection L2.

According to the above-described embodiment, the wireless communication device 200 can establish the wireless communication connection of the NW wireless communication system without the user inputting the setting information to the wireless communication device 200. Accordingly, not only the wireless communication device 100 but also other wireless communication devices (for example, the wireless communication devices 301 and 302) of the wireless LAN can use the service of the wireless communication device 200 via the wireless LAN. In particular, according to the above-described embodiment, the NAN connection between the wireless communication device 100 and the wireless communication device 200 is not disconnected immediately after the transmission of the setting information, but the NAN connection is disconnected when the wireless communication device 200 succeeds in the wireless communication connection of the NW wireless communication system. Therefore, even when the retransmission of the setting information is required, it is not necessary to establish an NAN connection again. Therefore, the amount of processing can be reduced.

Although the embodiment is described above, the present disclosure is not limited to the above-described embodiment, and can be appropriately modified without departing from the gist of the present disclosure.

In the example described above, the program includes an instruction group (or a software code) for causing the computer to perform one or more functions described in the embodiment when the program is read by the computer. The program may be stored in a non-transitory computer-readable medium or a tangible storage medium. Examples of the computer-readable medium or the tangible storage medium include, but are not limited to, a random access memory (RAM), a read-only memory (ROM), a flash memory, a solid-state drive (SSD) or other memory technologies, a CD-ROM, a digital versatile disk (DVD), a Blu-ray (registered trademark) disk or other optical disk storages, a magnetic cassette, a magnetic tape, and a magnetic disk storage or other magnetic storage devices. The program may be transmitted on a transitory computer-readable medium or a communication medium. Examples of the transitory computer-readable medium or the communication medium include, but are not limited to, electrical, optical, acoustic, or other forms of propagating signals.

A part or all of the above-described embodiment may be described as in the following appendixes, but are not limited thereto.

### APPENDIX 1

A wireless communication device including:
a first communication processing unit configured to establish a wireless communication connection of a first wireless communication system using setting information;
a second communication processing unit configured to search for at least one other wireless communication device according to a neighbor awareness network (NAN) standard and establish, with the at least one other wireless communication device, a wireless communication connection of a second wireless communication system different from the first wireless communication system, the second wireless communication system being a communication system according to the NAN standard; and
a transmission control unit configured to perform control to transmit the setting information to the at least one other wireless communication device using the wireless communication connection of the second wireless communication system, in which
the second communication processing unit is configured to disconnect the wireless communication connection of the second wireless communication system to the other wireless communication device when the other wireless communication device successfully establishes the wireless communication connection of the first wireless communication system.

### APPENDIX 2

The wireless communication device according to appendix 1, in which
the transmission control unit is configured to perform control to transmit the setting information to the other wireless communication device again using the wireless communication connection of the second wireless communication system when the other wireless communication device fails to establish the wireless communication connection of the first wireless communication system.

### APPENDIX 3

The wireless communication device according to appendix 1 or 2, in which
the other wireless communication device is a printing device, and
the transmission control unit is configured to perform control to transmit a print job to the other wireless communication device using the wireless communication connection of the second wireless communication system when the other wireless communication device fails to establish the wireless communication connection of the first wireless communication system.

### APPENDIX 4

The wireless communication device according to appendix 1 or 2, in which
the other wireless communication device is a printing device, and
when the wireless communication connection is disconnected after the establishment of the wireless communication connection of the first wireless communication system performed by the other wireless communication device is successful,
the second communication processing unit is configured to establish the wireless communication connection of the second wireless communication system with the other wireless communication device again, and
the transmission control unit is configured to perform control to transmit a print job to the other wireless communication device using the wireless communication connection of the second wireless communication system established again.

### APPENDIX 5

The wireless communication device according to any one of appendixes 1 to 4, further including:
a distance information acquisition unit configured to acquire, for each of the at least one other wireless communication device, distance information indicating a distance to the wireless communication device measured according to the NAN standard, in which
the transmission control unit is configured to limit a transmission destination of the setting information based on the distance information.

### APPENDIX 6

The wireless communication device according to any one of appendixes 1 to 5, further including:
a display control unit configured to perform control to display a list of the at least one other wireless communication device, in which
the transmission control unit is configured to determine a transmission destination of the setting information according to an instruction to select a transmission destination from the at least one other wireless communication device listed in the list.

### APPENDIX 7

The wireless communication device according to appendix 6, further including:
a distance information acquisition unit configured to acquire, for each of the at least one other wireless communication device, distance information indicating a distance to the wireless communication device measured according to the NAN standard, in which
the display control unit is configured to perform control to further display the distance information on each of the at least one other wireless communication device in the list.

### APPENDIX 8

The wireless communication device according to any one of appendixes 1 to 7, in which
the second communication processing unit is configured to search for the at least one other wireless communication device capable of providing a specific service according to the NAN standard by broadcasting an inquiry about a service, and
the transmission control unit is configured to perform control to transmit the setting information to the at least one other wireless communication device capable of providing the specific service.

### APPENDIX 9

A wireless communication device including:
a first communication processing unit configured to establish, with other wireless communication device, a wireless communication connection of a first wireless communication system according to an NAN standard;
a setting information acquisition unit configured to acquire setting information from the other wireless communication device using the wireless communication connection of the first wireless communication system; and
a second communication processing unit configured to establish a wireless communication connection of a second wireless communication system different from the first wireless communication system using the setting information, in which
the first communication processing unit is configured to disconnect the wireless communication connection of the first wireless communication system when the establishment of the wireless communication connection of the second wireless communication system is successful.

### APPENDIX 10

The wireless communication device according to appendix 9, in which
when the establishment of the wireless communication connection of the second wireless communication system is successful, the first communication processing unit is configured to disconnect the wireless communication connection of the first wireless communication system to a device other than the other wireless communication device and capable of communicating via the wireless communication connection of the second wireless communication system that is successfully established, among devices that are establishing the wireless communication connection of the first wireless communication system with the wireless communication device.

### APPENDIX 11

A method for controlling a wireless communication device, the method including:
establishing a wireless communication connection of a first wireless communication system using setting information;
searching for at least one other wireless communication device according to an NAN standard and establishing, with the at least one other wireless communication device, a wireless communication connection of a second wireless communication system different from the first wireless communication system, the second wireless communication system being a communication system according to the NAN standard;
performing control to transmit the setting information to the at least one other wireless communication device using the wireless communication connection of the second wireless communication system; and
disconnecting the wireless communication connection of the second wireless communication system to the other wireless communication device when the other wireless communication device successfully establishes the wireless communication connection of the first wireless communication system.

### APPENDIX 12

A method for controlling a wireless communication device, the method including:
establishing, with other wireless communication device, a wireless communication connection of a first wireless communication system according to an NAN standard;
acquiring setting information from the other wireless communication device using the wireless communication connection of the first wireless communication system;
establishing a wireless communication connection of a second wireless communication system different from the first wireless communication system using the setting information; and
disconnecting the wireless communication connection of the first wireless communication system when the establishment of the wireless communication connection of the second wireless communication system is successful.

### APPENDIX 13

A non-transitory computer-readable storage medium storing a program, the program causing a computer to execute:
a first communication processing step of establishing a wireless communication connection of a first wireless communication system using setting information;
a second communication processing step of searching for at least one other wireless communication device according to an NAN standard and establishing, with the at least one other wireless communication device, a wireless communication connection of a second wireless communication system different from the first wireless communication system, the second wireless communication system being a communication system according to the NAN standard;
a transmission control step of performing control to transmit the setting information to the at least one other wireless communication device using the wireless communication connection of the second wireless communication system; and
a disconnection step of disconnecting the wireless communication connection of the second wireless communication system to the other wireless communication device when the other wireless communication device successfully establishes the wireless communication connection of the first wireless communication system.

### APPENDIX 14

A non-transitory computer-readable storage medium storing a program, the program causing a computer to execute:
a first communication processing step of establishing, with other wireless communication device, a wireless communication connection of a first wireless communication system according to an NAN standard;
a setting information acquisition step of acquiring setting information from the other wireless communication device using the wireless communication connection of the first wireless communication system;
a second communication processing step of establishing a wireless communication connection of a second wireless communication system different from the first wireless communication system using the setting information; and
a disconnection step of disconnecting the wireless communication connection of the first wireless communication system when the establishment of the wireless communication connection of the second wireless communication system is successful.

What is claimed is:

1. A wireless communication device comprising:
a first communication processor configured to establish a wireless communication connection of a first wireless communication system using setting information;
a second communication processor configured to search for at least one other wireless communication device according to a neighbor awareness network (NAN) standard and establish, with the at least one other wireless communication device, a wireless communication connection of a second wireless communication system different from the first wireless communication system, the second wireless communication system being a communication system according to the NAN standard; and
a transmission controller configured to perform control to transmit the setting information to the at least one other wireless communication device using the wireless communication connection of the second wireless communication system, wherein
the second communication processor is configured to disconnect the wireless communication connection of the second wireless communication system to the other wireless communication device when the other wireless communication device successfully establishes the wireless communication connection of the first wireless communication system.

2. The wireless communication device according to claim 1, wherein
the transmission controller is configured to perform control to transmit the setting information to the other wireless communication device again using the wireless communication connection of the second wireless communication system when the other wireless communication device fails to establish the wireless communication connection of the first wireless communication system.

3. The wireless communication device according to claim 1, wherein
the other wireless communication device is a printing device, and
the transmission controller is configured to perform control to transmit a print job to the other wireless communication device using the wireless communication connection of the second wireless communication system when the other wireless communication device fails to establish the wireless communication connection of the first wireless communication system.

4. The wireless communication device according to claim 1, wherein
the other wireless communication device is a printing device, and
when the wireless communication connection is disconnected after the establishment of the wireless communication connection of the first wireless communication system performed by the other wireless communication device is successful,
the second communication processor is configured to establish the wireless communication connection of the second wireless communication system with the other wireless communication device again, and
the transmission controller is configured to perform control to transmit a print job to the other wireless communication device using the wireless communication connection of the second wireless communication system established again.

5. The wireless communication device according to claim 1, further comprising:
a distance information acquisition unit configured to acquire, for each of the at least one other wireless communication device, distance information indicating a distance to the wireless communication device measured according to the NAN standard, wherein
the transmission controller is configured to limit a transmission destination of the setting information based on the distance information.

6. The wireless communication device according to claim 1, further comprising:
a display controller configured to perform control to display a list of the at least one other wireless communication device, wherein
the transmission controller is configured to determine a transmission destination of the setting information according to an instruction to select a transmission destination from the at least one other wireless communication device listed in the list.

7. The wireless communication device according to claim 6, further comprising:
a distance information acquisition unit configured to acquire, for each of the at least one other wireless communication device, distance information indicating a distance to the wireless communication device measured according to the NAN standard, wherein
the display controller is configured to perform control to further display the distance information on each of the at least one other wireless communication device in the list.

8. The wireless communication device according to claim 1, wherein
the second communication processor is configured to search for the at least one other wireless communication device capable of providing a specific service according to the NAN standard by broadcasting an inquiry about a service, and
the transmission controller is configured to perform control to transmit the setting information to the at least one other wireless communication device capable of providing the specific service.

9. A wireless communication device comprising:
a first communication processor configured to establish, with other wireless communication device, a wireless communication connection of a first wireless communication system according to an NAN standard;
a setting information acquisition unit configured to acquire setting information from the other wireless communication device using the wireless communication connection of the first wireless communication system; and
a second communication processor configured to establish a wireless communication connection of a second wireless communication system different from the first wireless communication system using the setting information, wherein
the first communication processor is configured to disconnect the wireless communication connection of the first wireless communication system when the establishment of the wireless communication connection of the second wireless communication system is successful.

10. The wireless communication device according to claim 9, wherein
when the establishment of the wireless communication connection of the second wireless communication system is successful, the first communication processor is configured to disconnect the wireless communication connection of the first wireless communication system to a device other than the other wireless communication device and capable of communicating via the wireless communication connection of the second wireless communication system that is successfully established, among devices that are establishing the wireless communication connection of the first wireless communication system with the wireless communication device.

11. A method for controlling a wireless communication device, the method comprising:
establishing a wireless communication connection of a first wireless communication system using setting information;
searching for at least one other wireless communication device according to an NAN standard and establishing, with the at least one other wireless communication device, a wireless communication connection of a second wireless communication system different from the first wireless communication system, the second wireless communication system being a communication system according to the NAN standard;
performing control to transmit the setting information to the at least one other wireless communication device using the wireless communication connection of the second wireless communication system; and
disconnecting the wireless communication connection of the second wireless communication system to the other wireless communication device when the other wireless communication device successfully establishes the wireless communication connection of the first wireless communication system.

12. A method for controlling a wireless communication device, the method comprising:
establishing, with other wireless communication device, a wireless communication connection of a first wireless communication system according to an NAN standard;
acquiring setting information from the other wireless communication device using the wireless communication connection of the first wireless communication system;
establishing a wireless communication connection of a second wireless communication system different from the first wireless communication system using the setting information; and
disconnecting the wireless communication connection of the first wireless communication system when the establishment of the wireless communication connection of the second wireless communication system is successful.

13. A non-transitory computer-readable storage medium storing a program, the program causing a computer to execute:
a first communication processing step of establishing a wireless communication connection of a first wireless communication system using setting information;
a second communication processing step of searching for at least one other wireless communication device according to an NAN standard and establishing, with the at least one other wireless communication device, a wireless communication connection of a second wireless communication system different from the first wireless communication system, the second wireless communication system being a communication system according to the NAN standard;
a transmission control step of performing control to transmit the setting information to the at least one other wireless communication device using the wireless communication connection of the second wireless communication system; and
a disconnection step of disconnecting the wireless communication connection of the second wireless communication system to the other wireless communication device when the other wireless communication device successfully establishes the wireless communication connection of the first wireless communication system.

14. A non-transitory computer-readable storage medium storing a program, the program causing a computer to execute:
a first communication processing step of establishing, with other wireless communication device, a wireless communication connection of a first wireless communication system according to an NAN standard;
a setting information acquisition step of acquiring setting information from the other wireless communication device using the wireless communication connection of the first wireless communication system;
a second communication processing step of establishing a wireless communication connection of a second wireless communication system different from the first wireless communication system using the setting information; and
a disconnection step of disconnecting the wireless communication connection of the first wireless communication system when the establishment of the wireless communication connection of the second wireless communication system is successful.
